(19) United States
(12) Patent Application Publication
(10) Pub. No.: US 2007/0272271 A1
(43) Pub. Date: Nov. 29, 2007

(54) Apparatus and method for containing and collecting concrete wash residue

(76) Inventors: Wade Petrowich, La Quinta, CA (US); Anthony Vizl, Las Vegas, NV (US)

Correspondence Address: EDWIN TARVER, 16830 Ventura Blvd., SUITE 360, Encino, CA, 91436, US

(21) Appl. No.: 11/440,981

(22) Filed: May 25, 2006

(51) Int. Cl. B08B 7/04; B08B 3/04; B08B 3/00; B08B 3/12

(52) U.S. Cl. 134/10; 134/104.2; 134/110; 134/184

(57) ABSTRACT

The dispensing end of a concrete handling mechanism is positioned over a catch basin while a stream of washing water is directed at the working surfaces thereof so that the wash residue falls into the basin. The agitated liquid portion containing the reactive constituents of the concrete entrained therein are then passed into a collection enclosure through slotted filter housings that exclude the larger constituents of the concrete including sand and aggregate which further accumulate at the slots to form decanting weirs over which the liquid passes. The liquid collected in the enclosure may be concurrently pumped out while the accumulated aggregate residue is collected and disposed.

### BACKGROUND OF THE INVENTION

1. Field of the Invention

The present invention relates to wash residue containment structures, and more particularly to containment and collection structures useful in separating and confining contaminated washing fluids for neutralizing and/or disposal thereof.

2. Description of the Prior Art

The construction, mining and similar industries are frequently assisted by heavy machinery which at the end of its current task needs to be cleaned and otherwise prepared for its next use. Concrete handling equipment, in particular, demands periodic washings by the very nature of the concrete mix and its inherent hardening. Simply, the working surfaces of the mechanism need to be washed before the concrete sets up to limit the accumulation of hardened concrete thereon and in the course of a large construction project these repeated washings can produce substantial quantities of highly caustic liquid residue that then needs to be safely contained to limit any harm to the environment.

It should be appreciated that the proper disposal of washing fluids is no longer just a matter of good taste or good practice but is currently a subject of profound public concern and regulatory attention. Current damage to our environment is palpable and great public attention is now focused on any processes that either affect the pH of our waters or otherwise contaminate native chemistry balances. Of course, these concerns express themselves in regulatory enactments and enforcement consequences of these regulatory schemes, like the Clean Water Act, have recently resulted in several notoriously large penalty assessments.

Moreover, this Act, generally expressed in Title 40, Code of Federal Regulations, Sections 101 through 607, is on a constant amendatory path to include even more restrictive language and more robust penalty provisions as the cumulative impact of human activity on the environment approaches critical levels. All sorts of processes and mechanisms for the amelioration of the environmental consequence to any activity are now an inherent part of all commercial endeavors, compounded by a layered architecture of the regulatory schemes and enforcement agencies of the several States and municipal organizations. In consequence, one simply does not release wash residues into the environment anymore, nor does one accumulate or store it in any manner where an inadvertent spillage or release could occur.

In the past various containment structures have been devised which in one manner or another seek to collect and confine contaminated wash residues, exemplified by the teachings of U.S. Pat. Nos. 5,547,312 to Schmitz, Jr.; 6,648,008 to Price; and 5,099,872 to Tarvin et al. Each of the foregoing teachings describe an elastic or compliant containment structure that is laid on the ground to provide an erectable peripheral barrier for confining the draining wash fluids while such are concurrently pumped out into a collection container for disposal. While suitable for the purposes intended, the generally thin and compliant membranes that form these prior art structures do not fare well under heavy loads like concrete residue. Moreover, the flexible peripheral structure either has to be folded down for ingress or egress, a time consuming task, or like in the '312 patent for example, a pair of robust ramps needs to be positioned spanning over the periphery to allow the passage of the truck or other mobile structure that is to be washed into the containment basin, with the passage of heavy equipment over these temporarily positioned ramps consuming inordinate amounts of labor and equipment time. These labor intense aspects are particularly bothersome in large construction projects where great amounts of pre-mixed concrete are brought to the site in a sequenced train of transit mixer trucks, each truck and its associated pumping or delivery mechanism thereafter requiring a fairly thorough washing right at the site before returning to the concrete plant.

This continuing product of the wash process is currently accumulated in large containers in which the upper water strata of the wash residue contain the caustic liquid that, with time, then promote the further setting and hardening of the heavier residues layered on the container bottom. Of course, once fully set up these bottom layers are chemically inert and only the left-over liquid layer obtains any containment and disposal attention. The remaining, fully set up and hardened bottom pad is then physically lifted with the container and dumped as land fill.

It bears emphasis that the foregoing practice leaves the constituents of a highly diluted cement mix stationary, giving time for the reactive components of the concrete process to interact towards a harder, more difficult to handle, residue pad. Since the strength of a diluted cement mix is compromised any mechanism that separates the liquid and solid residue streams on a continuous basis will greatly simplify the eventual disposal task while also reducing congestion at the work site cluttered by stationary containers each full of caustic water on top of a well hardened bottom cake. A mechanism that effectively resolves these concerns is of a particular current interest in the heavy construction business and it is one such mechanism that is disclosed herein.

### SUMMARY OF THE INVENTION

Accordingly, it is the general purpose and object of the present invention to provide a containment structure for concrete equipment wash residue which includes means for separate containment of the wash liquid in accordance with the accumulation of the solid debris.

Other objects of the invention are to provide a movable containment structure useful in containing concrete wash slurry and decanting in accordance with the accumulation of solid debris the liquid portion of the slurry for separated storage thereof.

Further objects of the invention are to provide a containment structure for collecting concrete wash slurry defined by a solid residue portion and a liquid storage portion separated by communication paths conformed to define liquid overflow weirs in accordance with the accumulation height of debris in the solid residue portion.

Yet additional objects of the invention are to provide a concrete wash slurry containment structure in which the liquid part of the slurry is separated from the solid debris for separated treatment or storage.

Briefly, these and other objects are accomplished within the present invention by providing a generally rectangular containment structure defined by a bottom surface rolled in generally arcuate bends to form opposing, vertically aligned side walls each extending between transversely aligned front and rear end surfaces to form a storage cavity therebetween. Yet another transversely aligned intermediate wall extends across the cavity adjacent the front surface to separate the cavity into a front and rear portions, the front portion conformed as a generally rectangular chamber closed from the environment by a covering top surface. The open rear cavity portion is then useful to collect the wash residue that falls from concrete handling devices that are brought to the rear wall to be washed while extending thereover through a horizontally hinged upper gate panel pivoted from the upper edge of a lower gate panel extending across the rear surface to present a threshold height when the upper panel is opened that accommodates the lowest one of the various devices supported on ground and to allow the eventual disposal of the accumulated debris when the lower panel is released.

Those skilled in the art will appreciate that in the course of washing concrete handling devices the liquid portion of the wash residue will entrain in the wash flow the unbound constituents of cement as various hydroxides and will thus be highly caustic while the solid part of the wash residue is effectively inert. The distinct nature of these two parts of the residue stream inherently entail wholly distinct handling and storage constraints, one part comprising sand and gravel with the other caustic liquid part presenting the primary environmental concerns. Since washing efficacy relates directly to the amount of water used and its stream energy there is an inherent dilution of the constituents of cement which degrades their bonding of the solid residue, thus greatly simplifying its removal from the collection cavity. A flexible membrane may be placed in the basin nonetheless, both to control any leakage and/or to minimize those instances where some residual cement paste may bond the solid residue to the basin walls.

For these reasons a liquid conveyance facility is provided within the present invention for draining off the liquid from the generated concrete wash slurry and conveying it to the front storage chamber from where it may be pumped into containers and thereafter neutralized. This conveyance is effected through a pair of laterally spaced and vertically aligned cylindrical housings that form a part of the separation wall, each housing spaced in the wall adjacent a corresponding one of its two lateral ends. That part of the cylindrical surface of each housing that extends into the rear cavity forming the wash collection tray is provided with a narrow vertical slot extending substantially over its full length while the opposite cylinder surface is perforated by an opening of substantial dimensions. A conformingly mated filter assembly is then insertable in each of the housings to limit transmission of particulates into the front storage chamber and concurrent therewith to insure an accumulation of the solid debris across the slot to effectively form a decanting weir.

It will be appreciated that this structural combination resolves all the currently competing aspects of proper cleaning of concrete handling equipment in an assembly that can be conveniently mounted on skids for movement along with the movement of the construction site. The same skid base may also include the necessary inclinations for proper draining alignment and also all such roller provisions as may be needed. Of course, the liquid storage chamber may further include connection fittings for the necessary pump-out and the solid debris portion may include all such fairing provisions that would assist in the removal of the debris. The continuous separation of the diluted cement bearing wash product stream thus removes with it the reagents of the hydration process, reducing the efficacy thereof within the remaining residue. This separation process, therefore, simplifies the disposal of the inert aggregate residue while at the same time confining the hazardous constituents for neutralizing or other processing.

### BRIEF DESCRIPTION OF THE DRAWINGS

FIG. 1 is a perspective illustration, separated by parts, of the inventive concrete wash containment and collection structure;

FIG. 2 is a further perspective illustration of the inventive concrete wash collection and containment structure illustrated in FIG. 1 in its assembled configuration;

FIG. 3 is a side view detail, in partial section, of one of several filter housings in accordance with the present invention;

FIG. 4 is a side view, in section, of the inventive concrete wash containment and collection structure taken along line 4-4 of FIG. 2;

FIG. 5 is a process flow diagram illustrating the operation of the inventive concrete wash containment and collection structure in its continuous mode of operation;

FIG. 6 is a perspective detail of the rear gate assembly in accordance with the present invention; and

FIG. 7 is a side view of the inventive concrete wash containment and collection structure inclined for removal of the solid debris accumulated therein.

### DESCRIPTION OF THE PREFERRED EMBODIMENT

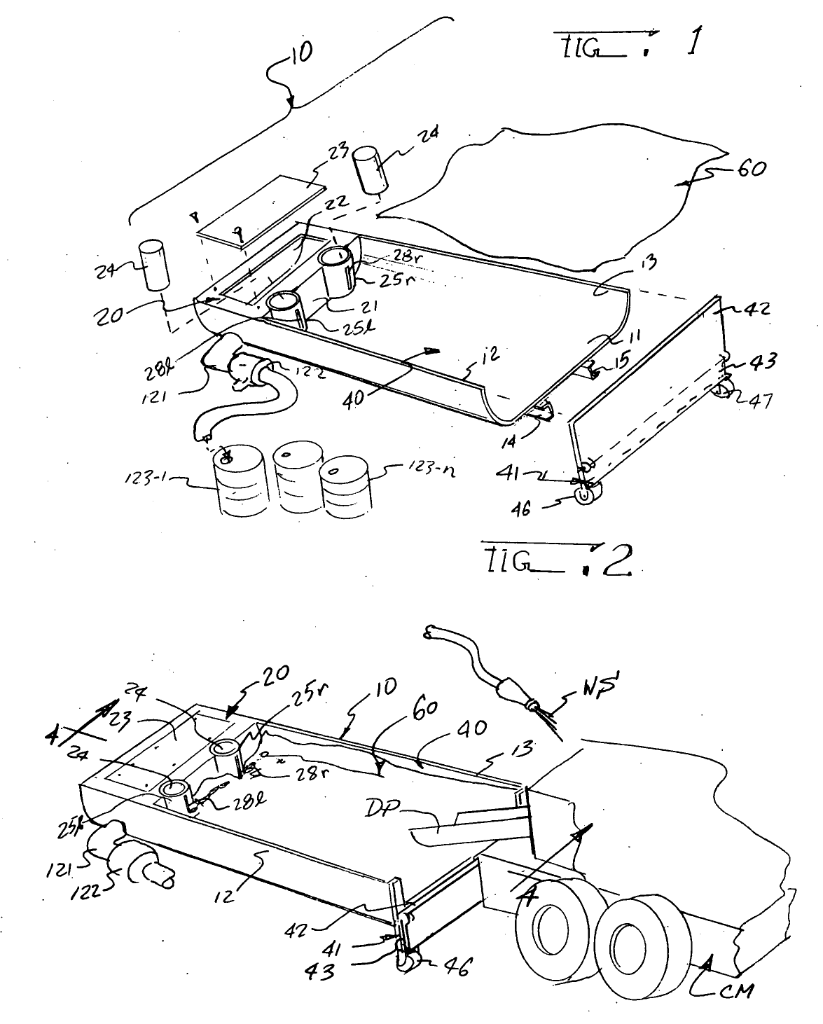

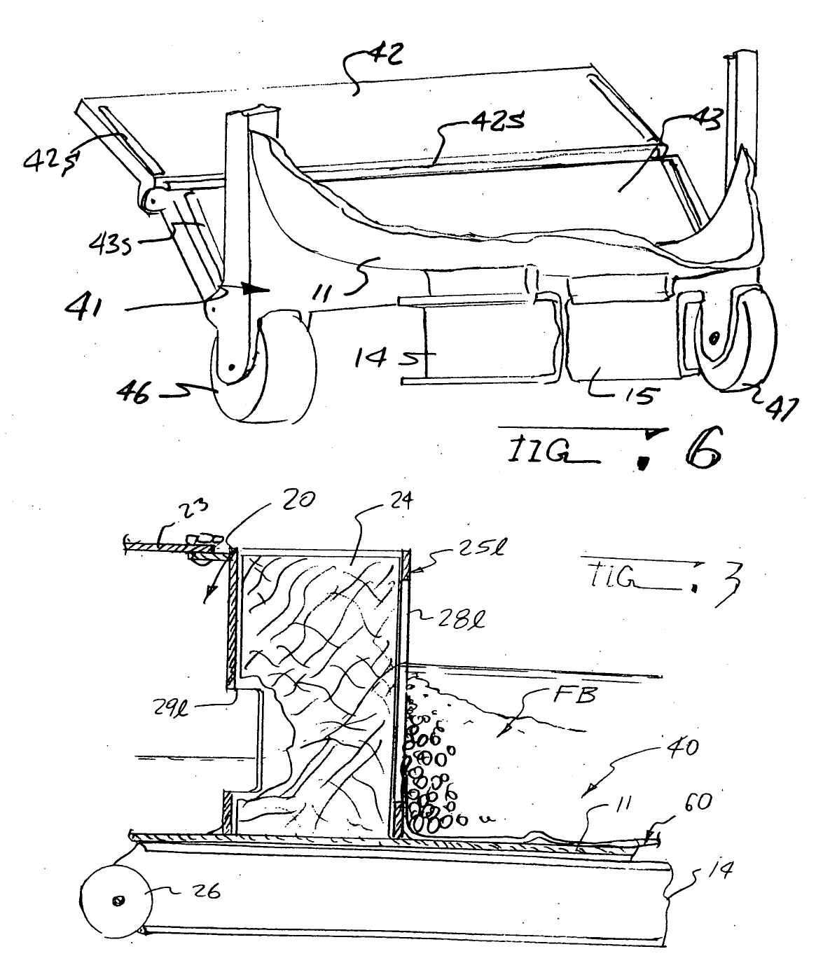

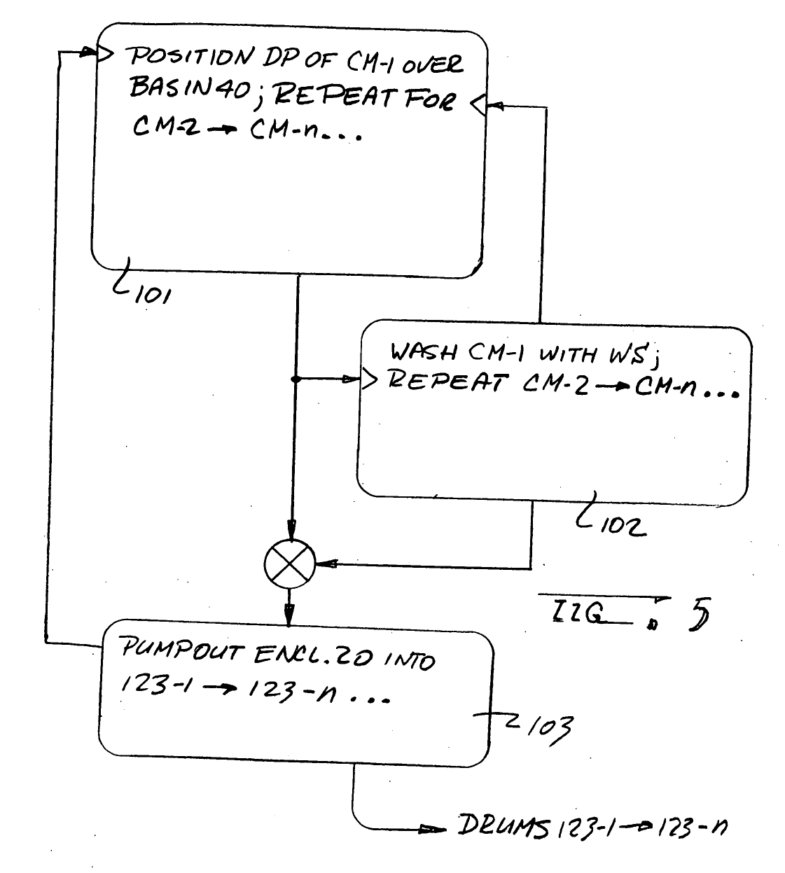

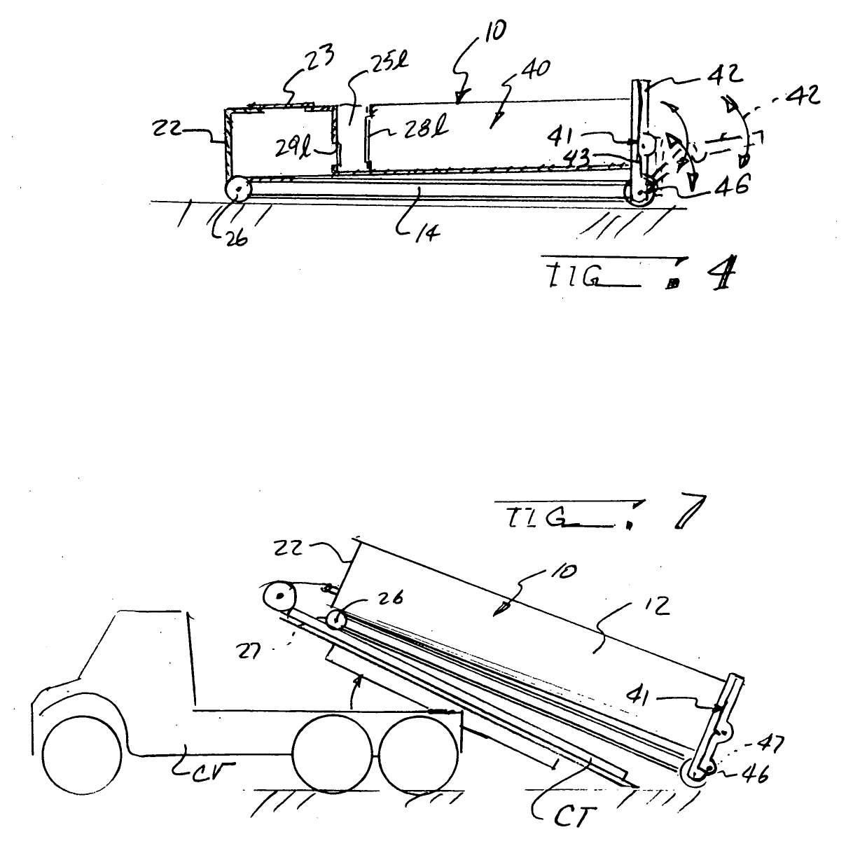

As shown in FIGS. 1-4 and 6, the inventive concrete wash containment and collection structure, generally designated by the numeral 10, is substantially configured as an elongate collection trough formed by rolling the lateral edges of a rectangular bottom plate 11 along axes that are partly spread from a parallel alignment to form side walls 12 and 13 separated by an increasing width from the narrower trough dimension at its forward end. A vertical transverse wall 21 extends across the trough next to its forward end dividing the cavity into a forward enclosure 20 closed at the forward trough edge by a vertical end panel 22 and covered from the environment by a top access plate 23 to form an impervious closed structure in which liquids may be stored. The larger remaining portion of the trough that extends beyond the separating wall 21 then forms an open rear basin 40 closed at the rear edge by rectangular panel assembly 41 provided with an upper and lower horizontal gate panels 42 and 43 hinged to each other and to the lower edge of assembly 41 so that when the upper panel 42 is opened, a threshold is set to the minimum height above ground for any structure that is extended thereover and when both the upper and lower panels are released full evacuation of basin 40 is then effected.

This structural combination may be supported on ground on a pair of C-channel sectioned skids 14 and 15 extending longitudinally beneath bottom panel 11 in a spaced alignment relative the bottom surface, with the channel spacing fixed by the lower edge projection 41L of panel assembly 41 at one end to a direct contact with the bottom panel 11 at the forward edge. In this manner a forwardly biased downward inclination of the bottom panel 11 extending between the lateral walls 12 and 13 is provided to direct the fluid flows towards wall 21. A set of outer rollers 46 and 47 at the lower corners of panel 41 then provides rolling convenience over ground while another set of support rollers 26 and 27 fitted adjacent the skid channels 14 and 15 at the forward end are useful in loading and unloading the structure onto tracks in a carrier vehicle CV. Once thus deployed either gate 42 is opened to allow the dispensing part DP of the washed concrete machinery CM to extend over the rear basin 40 for collecting the wash products therein that are emitted through the dispensing part DP when the machinery is washed.

Those skilled in the art will appreciate that the concrete setting process using portland cement entails a hydration reaction of the oxides of calcium, silicon and aluminum. As the hydration solids are formed the heat of their reaction, over time, drives off the excess local water that is not chemically bound as steam. This process, however, loses efficacy once an overabundant amount of water is introduced, as in the course of a wash, since the excess water flow rinses off the cement powder off the aggregate, diluting it to a point where the reaction is no longer sustainable. A thorough washing, therefore, invariably results in wholly loose aggregate along with large quantities water carrying the highly diluted cement which when allowed to evaporate to higher concentrations within the aggregate may start binding it to itself and to the walls of the container. While the bonds that result in the course of evaporation are minimally effective their result is, nonetheless, bothersome as any prolonged retention of even the highly diluted cement reagents within the residue aggregate following washing will promote hydration. For this reason, and those imposed by statute focused on limiting inadvertent spillage, a flexible membrane 60 may be positioned in basin 40 to be recovered once the residue is disposed.

If needed, membrane 60 is laid in basin 40 leaving exposed the conveyance paths for a controlled draining of wash fluid that also carries away with it the diluted cement powders forming the paste for collection in enclosure 20, while at the same time separating and leaving behind the sand and washed aggregate in basin 40. To effect this the separation wall 21 includes a pair of vertically aligned tubular housings 25l and 25r each straddling the plane of the wall proximate the corresponding right or left side wall 12 or 13 within conforming wall surface gaps. Both the housings 25l and 25r are provided with a corresponding narrow vertical slot 28l and 28r formed in that portion of their walls that extends into the basin 40 while substantially larger openings 29l and 29r are formed in the opposing housing surfaces that extend into enclosure 20, thereby forming a liquid communication path thereacross. A set of conforming cylindrical filter assemblies 24 are then each receivable in the corresponding housings 25l and 25r to control and limit any transfer of the larger sized particulates of the aggregate. After insertion filters 24 may be periodically turned relative the slots to present a fresh surface to the flow. Preferably, the vertical slots 28l and 28r are each of a narrow transverse width dimension that is smaller than the dimension of the bulk of the aggregate. Consequently, the aggregate and sand will accumulates at each of the slots to form a filtering bed FB that further limits any aggregate transfer into enclosure 20.

Those skilled in the art will further appreciate that any concrete equipment washing is best effected by substantial and robust water streams. Simply, since the concrete transit and pumping equipment, in itself, provides a fairly integral enclosure having few exit openings robust washing stream WS is needed to reach all the interior surfaces thereof. As result the wash product flows that emerge from the washed mechanism are themselves quite agitated, thus providing the energy in basin 40 to further disturb the aggregate beds that have collected therein. In the course of this further agitation any of the cement paste that may remain in the bed is further dispersed and diluted, thereby limiting any potential of setting of the wash products therein. The resulting aggregate bed that accumulates at each entry slot will therefore remain in its loose form for convenient disposal out of the basin once it is full. The same deposit of the sand and aggregate filter bed FB at each slot 25l and 25r also serves a decanting purpose since the higher strata of the agitated basin content will inherently contain the lower density, or more diluted, cement paste flows. Accordingly, the inventive structural arrangement synergistically obtains benefit from the washing process itself to separate the diluted concrete paste from the aggregate, thereby simplifying the removal and disposal of the inert and massive part of the wash product while the caustic hydroxide parts of the hydration reaction are separately collected for neutralization and disposal.

For these reasons the enclosure 20 is further provided with a pump-out port 121 which may be periodically connected to a powered pump 122 that transfers its caustic contents into drums 123-1 through 123-n to be thereafter neutralized and disposed. By particular reference to FIG. 5 the foregoing inventive structure renders a sequence or process possible wherein in step 101 the dispensing parts DP of a sequence of concrete machinery CM-1 through CM-n are brought seriatim to the rear panel assembly 41 and extended over the basin 40 through the fully opened gate 42 selected to clear the lowest dispensing part above ground. Once in position, in step 102, the interior surfaces of the machinery are washed by a pressurized water stream WS with the wash product flow falling into the basin where the cement paste is separated by decanting and/or filtering and collected in enclosure 20. From there, in step 103, it is pumped into storage drums 123-1 through 123-n with steps 101, 102 and 103 occurring both contemporaneously and/or in sequence. As illustrated in FIG. 7 structure 10 with the decanted debris collected in the basin 40 are then lifted onto a carrier vehicle CV that transports it for disposal. In the course of this lifting the outer rollers 46 and 47, together with the rear edges of the skid channels 14 and 15, form a fulcrum line on the ground while the forward end is lifted to place rollers 26 and 27 on corresponding tracks CT in the carrier vehicle. Of course, this pivotal motion results in a realignment of the weight vector relative the basin structure towards the more spread out rear end of plate 11 which, because of its lower sectional area moment of inertia, will result in wall and panel flexures that assist in the further fracturing of the debris collected thereon. It will be appreciated that gate panels 42 and 43 need to be fully closed during such lifting to limit any spillage, each panel further including a peripheral seal 42s and 43s to prevent leakage while stationary or during transport. Once transported to the disposal site the further weight vector movement and panel flexures assist in additional fracturing of the debris pad for convenience in the disposal thereof and the recovery of the membrane 60.

In this manner the problematic components of the concrete process, i.e., the highly caustic hydroxides that are entailed in the hydration processes of concrete, are separated from the wash product stream right as it is being generated, diluting and removing at the same time the binder from the inert filler aggregate. Convenient handling of the compromised and fractured aggregate pad, the most massive part of the wash residue, is thus obtained while the component most harmful to the environment is isolated for neutralization and disposal in standardized drums, allowing for the handling and transport thereof by separately contracted enterprises that have the necessary expertise and facilities.

Of course, where the physical capacity limits of a single structure 10 may be insufficient for the concrete building project undertaken multiples thereof may be deployed at a single construction site with each structure sized for convenient handling and disposal movement along the same paths as those used by the concrete machinery. Thus both the job planning and the environmental aspects are comfortably conformed for the usual transport modes.

Obviously many modifications and variations of the instant invention can be effected without departing from the spirit of the teachings herein. It is therefore intended that the scope of the invention be determined solely by the claims appended hereto.

We claim:

1. Apparatus for collecting the wash residue produced in the course of cleaning concrete handling machinery and emitted from the concrete dispensing portions thereof, said residue including the constituent parts of concrete together with the water stream introduced in the course of washing, comprising:
an elongate containment structure defined by a forward and a rear end including a liquid impervious enclosure in the forward portion thereof for storing fluids and a rear basin open at the top and conformed to fit subjacent said dispensing portion of said concrete handling machinery for containing said wash residue emitted therefrom; and
filtering means interposed between said basin and said enclosure for separating and retaining in said basin the substantial portions of the sand and aggregate included in said constituents of concrete and for conveying the remainder of said residue including the substantial portion of the cement portion of said concrete mixed with said water stream into said enclosure.

2. Apparatus according to claim 1, further comprising.
pumping means selectively connected to said enclosure for pumping said cement mixed with water therefrom.

3. Apparatus according to claim 1, wherein:
said filtering means includes a housing having a first wall extending into said basin and a second wall extending into said enclosure to form a cavity therebetween, said first wall including a generally vertical slot communicating between said basin and said cavity and said second wall including an opening communicating between said cavity and said enclosure.

4. Apparatus according to claim 3, further comprising:
a filter assembly conformed for mating receipt within said cavity.

5. Apparatus according to claim 4, further comprising.
pumping means selectively connected to said enclosure for pumping said cement mixed with water therefrom.

6. Apparatus for collecting the wash residue produced in the course of washing concrete handling machinery and emitted from the concrete dispensing portions thereof, said residue including the constituent parts of concrete including sand and aggregate together with the cement mixed into the water stream introduced in the course of washing, comprising:
an elongate containment structure defined by a forward and a rear end including a liquid impervious enclosure in the forward portion thereof for storing fluids and a rear basin open at the top and conformed to fit subjacent said dispensing portion of said concrete handling machinery for containing said wash residue emitted therefrom; and
one or more filter housings each having a first wall extending into said basin and a second wall extending into said enclosure to form a cavity therebetween, said first wall including a generally vertical slot communicating between said basin and said cavity and said second wall including an opening communicating between said cavity and said enclosure each said slot being of a width selected for retaining in said basin the substantial portions of the sand and aggregate included in said constituents of concrete and for conveying the remainder of said residue including the substantial part of said cement portion of said concrete mixed with said water stream into said enclosure.

7. Apparatus according to claim 6, further comprising.
pumping means selectively connected to said enclosure for pumping said cement mixed with said water stream therefrom.

8. Apparatus according to claim 7, further comprising:
one or more filter assemblies each conformed for mating receipt within one of said cavities.

9. Apparatus according to claim 6, wherein:
said basin includes a wall around the periphery thereof provided with a gate conformed to provide access clearance for the extension of said dispensing portion over said basin.

10. Apparatus according to claim 9, wherein:
said gate is sealably engageable to said peripheral wall.

11. Apparatus according to claim 10 further comprising.
pumping means selectively connected to said enclosure for pumping said cement mixed with said water stream therefrom.

12. Apparatus according to claim 11, further comprising:
one or more filter assemblies each conformed for mating receipt within one of said cavities.

13. A method for containing the wash residue generated in the course of washing of concrete handling equipment provided with a concrete dispensing portion by directing a stream of washing water into the interior thereof, comprising the steps of:
positioning the concrete dispensing portion of said concrete handling equipment over a basin for capturing the wash residue comprising the constituents of concrete mixed with said stream of washing water;
transmitting the liquid portion of said wash residue having the cement constituents suspended therein into an impervious enclosure while excluding therefrom the substantial portions of the sand and aggregate constituents of concrete; and
pumping from the impervious enclosure into transportable containers the liquid portion of said wash residue.

14. A method according to claim 13 wherein:
the step of transmitting the liquid portion includes the further step of filtering said wash residue to separate the liquid portion therefrom.

15. A method according to claim 14, wherein:
the step of filtering further includes the step of accumulating the sand and aggregate portion of the wash residue to form a decanting weir in the step of transmitting the liquid portion.

16. A method according to claim 13 wherein:
the step of transmitting the liquid portion is effected concurrent with the directing of the washing stream.

17. A method according to claim 16 wherein:
the step of pumping from the impervious enclosure is effected concurrent with the step of transmitting the liquid portion washing stream.

18. A method according to claim 17 wherein:
the step of transmitting the liquid portion includes the further step of filtering said wash residue to separate the liquid portion therefrom.

19. A method according to claim 18, wherein:
the step of filtering further includes the step of accumulating the sand and aggregate portion of the wash residue to form a decanting weir in the step of transmitting the liquid portion.
